(19) United States
(12) Patent Application Publication
(10) Pub. No.: US 2006/0213942 A1
(43) Pub. Date: Sep. 28, 2006

(54) System and method for a removable materials carrier for sides of vehicles

(76) Inventors: Luis Arnando Gomez, Houston, TX (US); Julio da Cunha, Houston, TX (US); Dana L. Schnitzer, Houston, TX (US); Gary R. Maze, Houston, TX (US)

Correspondence Address: Gary R. Maze, 5707 Spellman, Houston, TX, 77096, US

(21) Appl. No.: 11/088,505

(22) Filed: Mar. 24, 2005

(51) Int. Cl. B60R 9/00; B60R 11/00

(52) U.S. Cl. 224/532; 224/493; 224/546

(57) ABSTRACT

A removable load tote system and method for securing materials to a side of an vehicle are disclosed. In an embodiment, the load tote system comprises a locking block adapted for being secured underneath a hood of an vehicle; a strip having a first end and second end, the first end having an aperture, and an inside and an outside; a hood strap securely connected to the locking block, the hook strap passing through the aperture in the strip and further passing through a slider useful for securely adjusting a length of the hood strap; a flange having a first end and a second end, the first end securely connected to the outside of the strip, the flange further comprising a first aperture disposed proximate the first end of the flange and a second aperture disposed proximate the second end of the flange; a hook having an aperture; a well strap; and a well strap lock. The well strap is securely connected to the second end of the strip and passes through the first and second apertures of the flange, the well strap lock, and the hook aperture. It is emphasized that this abstract is provided to comply with the rules requiring an abstract which will allow a searcher or other reader to quickly ascertain the subject matter of the technical disclosure. It is submitted with the understanding that it will not be used to interpret or limit the scope of meaning of the claims.

### BACKGROUND OF THE INVENTION

1. Field of the Invention

The present inventions relate to the field of materials carriers suitable for use with vehicles. More specifically, the present inventions relate to removable carriers capable of securing loads to a side of an vehicle.

2. Description of the Related Art

It is often desirable to use a vehicle not normally intended to be used as a materials handler to carry materials. For example, families often use one of the family cars to haul project materials from a source such as a lumber store or warehouse back to a house or other location, e.g. wood beams, pipes, plants, and the like.

Typically, people will place these materials inside their vehicle such as by passing the material through one or more windows or place the materials on the outside of their vehicle such as by having the material straddle their vehicle from front to back.

The prior art has suggested numerous temporary, removable carrying devices. By way of example, U.S. Pat. No. 6,244,482 to Gyarmaty is illustrative. Gyarmaty '482 teaches a carrying device to be used on the top of a vehicle. The carrying device is secured by hooks connected to tensioned straps.

U.S. Pat. No. 6,209,768 to Boaz is similar but teaches a device for carrying materials where the carrier is mounted to a trunk lid of the vehicle.

A problem with the prior art solutions is that they are not useful for long materials such as lumber or pipes. Further, even materials of moderate weight may negatively impact a vehicle's roof and using a trunk lid or hood may unacceptably interfere with visibility. None of the prior art teaches carriers that are removably mounted to a side of a vehicle.

Therefore, there is a need to have a removable materials carrier that will not unacceptably interfere with visibility and that can be adapted to handle loads longer than the width of the vehicle.

### BRIEF DESCRIPTION OF THE DRAWINGS

These and other features, aspects, and advantages of the present invention will become more fully apparent from the following description, appended claims, and accompanying drawings in which:

FIG. 1 is a plan view in partial perspective of an exemplary embodiment of the present inventions;

FIG. 2 is a plan view in partial perspective of an exemplary embodiment of the present inventions;

FIG. 3 is a plan view in partial perspective of an exemplary set of small parcel holder of the present inventions; and

FIG. 4 is a plan view in partial perspective of an exemplary roof carrier straps.

### DETAILED DESCRIPTION OF A PREFERRED EMBODIMENT

As used herein, “material” may be a metal, plastic, glass, paper, organic material, composite, or other material that can be safely carried by an vehicle. Vehicle is defined to mean a driver operated or controlled vehicle such as a car, station wagon, sport utility vehicle (“SUV”), van, minivan, or truck that has at least a fender and at least one of a hood or a trunk lid. “Hood” is understood to mean an engine compartment hood or a trunk lid.

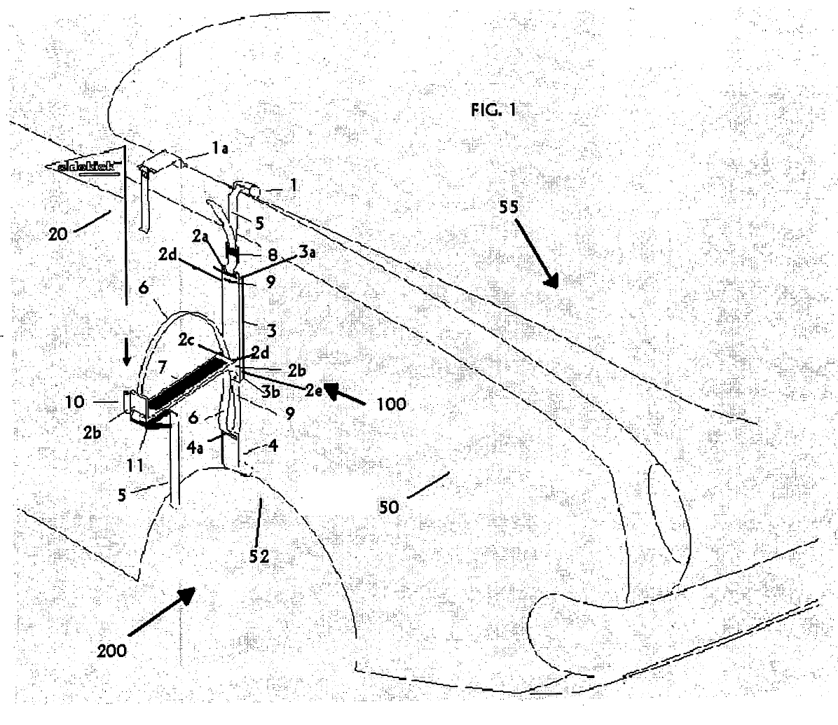

Referring now to FIG. 1, a plan view in partial perspective of an exemplary embodiment of the present inventions, the adjustable load tote of the present invention, generally referred to herein by the number “100,” comprises locking block 1 adapted to be secured underneath hood 55 of vehicle 200; strip 3 having first end 3a and second end 3b, first end 3a having aperture 3c, an inside, and an outside; hood strap 5 securely connected to locking block 1, hood strap 5 adapted to pass through aperture 3c in strip 3 and further to pass through adjuster 8, shown in FIG. 1 as slider 8, useful for securely adjusting a length of hood strap 5; flange 2 having first end 2a and second end 2b, first end 2a securely connected to the outside of strip 3, flange 2 further comprising first aperture 2d disposed proximate first end 2a of flange 2 and second aperture 2e disposed proximate second end 2b of flange 2; hook 4 having aperture 4a; well strap lock 11; and well strap 6.

Vehicle 200 has hood 55. Load tote 100 may be positioned and secured against fender 50 of vehicle 200. It is understood that fender 50 is a side portion of vehicle 200 and may be a front fender, a rear fender, a side door, a side panel, or a combination thereof.

Locking block 1 may be of any appropriate shape such as generally tubular as shown in FIG. 1 or angular such as locking block 1a additionally shown in FIG. 1 which may be used in a further embodiment instead of a tubular locking block 1. In general, locking block 1 comprises a material that is durable and can sustain exposure to heat and cold such as may be present in the presence of an engine for vehicle 200. Additionally, locking block 1 may assume a novelty shape such as one comprising a first, substantially planar member and a step-shaped endpiece. (not shown in the figures) as long as locking block 1 can be maintained in a desired position once hood 55 is closed. For example, locking block 1 may be a school or organization emblem or other identifier, a trademark, a fanciful shape, or the like.

Hood 55 is typically opened to admit locking block 1. When closed, hood 55 secures locking block 1 into a predetermined position.

Hood strap 5 is attached at first end 5a to locking block 1. In a currently envisioned embodiment, hood strap 5 may be molded into locking block 1 or inserted through locking block 1 such as through a hole or slot in locking block 1 and then secured by numerous equivalent means as will readily familiar to those of ordinary skill in the manufacturing arts. In a preferred embodiment, hood strap 5 is permanently fitted with locking block 1 but can be removably fitted such as for replacement of locking block 1 or hood strap 5.

In a currently envisioned embodiment, once hood strap 5 is fitted to locking block 1 in accordance with the teachings of the present inventions, a second end of hood strap 5 may pass through adjuster 8. In this embodiment, adjuster 8 provides for adjustments of hood strap 5, by way of example and not limitation such as for tensioning of hood strap 5.

In the preferred embodiment, first hood strap 5 passes through slot 3c in first end 3a of strip 3. Strip 3 is typically disposed intermediate flange 2 and fender 50 and comprises a material that can support flange 2 and the loads flange 2 will carry. Additionally, strip 3 may be constructed of a material that affords some protection to fender 50 of vehicle 200 and its finish. In alternative embodiments, strip 3 may be faced with an appropriate material to provide the protection to fender 50, by way of example and not limitation including rubber, plastic, foam, carpet, and the like, or combinations thereof. In a preferred embodiment, strip 3 is approximately six inches long but can vary from around two inches to around eighteen inches in length. Additionally, strip 3 may assume a novelty shape (not shown in the figures) as long as strip 3 can be maintained in a desired position once hood 55 is closed. For example, strip 3 may be a school or organization emblem or other identifier, a trademark, a fanciful shape, or the like.

Flange 2 is connected to strip 3 such as at flange first end 2a. In alternative embodiments, flange 2 and strip 3 may be manufactured as a single component. Flange 2, if not a single component with strip 3, may be attached to strip 3 in any appropriate method, by way of example and not limitation such as with rivets, brads, screws, glue, or their equivalents. In currently envisioned embodiments, flange 2 may further comprise a hinge (not shown in the figures) located proximate flange first end 2a to facilitate storage and secure load tote 100 to a side of vehicle 200 when not carrying materials.

A portion of flange 2 protrudes substantially perpendicularly from strip 3 a sufficient length to allow transport of materials. In a preferred embodiment, the portion of flange 2 protrudes substantially perpendicularly from strip 3 approximately twelve inches although this can vary from about four inches to about twenty four inches. In certain embodiments, the protruding portion of flange 2 may be adjustably extensible in length.

Grip 7 may be present on a surface of flange 2 to aid in securing materials to be carried. In a preferred embodiment, grip 7 is constructed of a material such as plastic or rubber and secured onto flange 2 such as with glue. In additionally envisioned embodiments, grip 7 may be integrated into flange 2 such as a contoured surface formed by injection molding, stamping, machining, or the like.

Flange edge 2b is disposed distally from fender 50 and may be upturned, as indicated in FIG. 1. Well strap lock 11 may be located proximate flange end 2b. In a preferred embodiment, well strap lock 11 is secured onto a bottom portion of flange 2. In alternate embodiments, well strap lock 11 may be secured onto flange end 2b or at least partially integrated into flange end 2b.

Well strap 6 is attached to strip end 3b and passes through slot 4a in hook 4. Well strap 6 further passes through slot 2d located proximate flange end 2c and then through slot 2e located proximate flange end 2b. Additionally, an end of well strap 6 adjustably passes through well strap lock 11. In currently envisioned embodiments, well strap lock 11 may include a tensioner (not shown in the figures) such as a ratcheting tensioner.

Well strap 6 passes through a portion of hook 4 which is placed to secure load tote 100 against a lip of wheel well 52. Hook 4 may be constructed out of a metal or a plastic having sufficient strength to secure load tote 100. Additionally, an interior portion of hook 4 may be faced with a cushioning buffer material such as rubber or plastic to help prevent damage to wheel well 52 or fender 55. The material may further aid in the gripability of hook 4 and may further comprise contours, bumps, and the like.

In a preferred embodiment, hood strap 5 and well strap 6 are constructed of a material having an appropriate tensile strength to secure loads in load tote 100, those loads typically ranging from around a few ounces to around two hundred pounds. In currently envisioned alternative embodiments, hood strap 5 and well strap 6 may be a single strap.

In certain embodiments, flag holder 10 may be located proximate flange end 2b and adapted to receive flag 20.

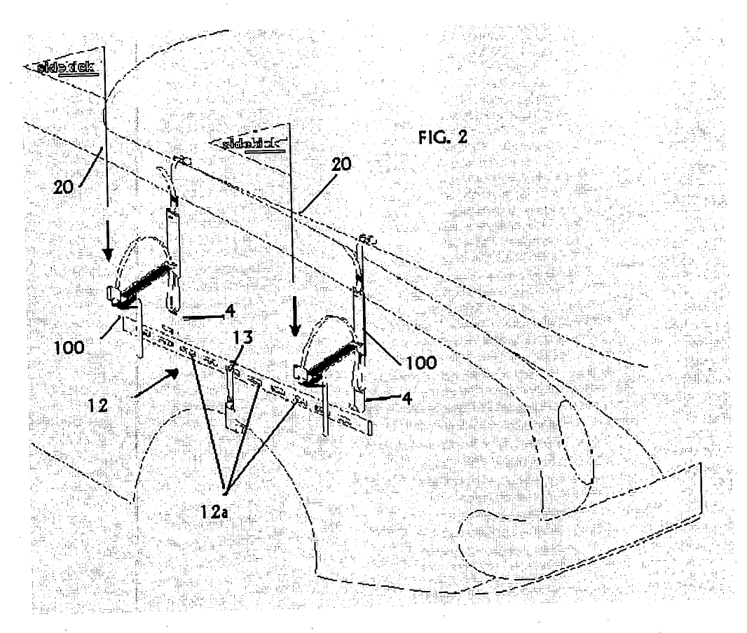

Referring now to FIG. 2, a plan view of an exemplary embodiment of the present inventions in partial perspective, in certain embodiments a plurality of load totes 100 may be used. Bar 12 may be constructed of material similar if not identical to the material used for strip 3 (FIG. 1). In a preferred embodiment, bar 12 contains a plurality of hook slots 12a. Bar strap 13 is connected to hook 4. In a preferred embodiment, bar strap 13 is of a fixed length but can be adjustable in an appropriate manner as will be familiar to those of ordinary skill in the art, including using a well strap lock 11 (FIG. 1). Hook 4 of load tote 100 may be reversed to better fit into bar 12 and protect the finish surface of fender 50 (FIG. 1).

Additionally, although the slots for load tote 100 and bar 12 are shown in FIG. 1 and FIG. 2 as substantially rectangular or obround, e.g. slots 4a, these slots may be of a substantially arcuate shape such as a crescent.

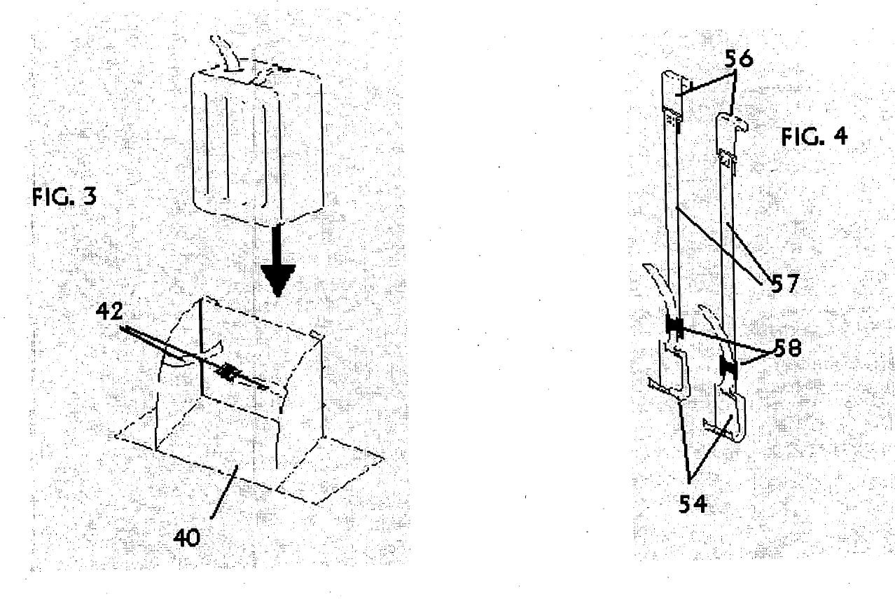

Referring now to FIG. 3, a plan view in partial perspective of an exemplary small parcel holder of the present invention, carrier 40 may be positioned on flange 2 (FIG. 1) and secured such as by using well strap 6 (FIG. 1). Carrier 40 may be appropriate for use with small loads, by way of example and not limitation including gasoline cans, paint cans, boxes, and the like.

Referring now additionally to FIG. 4, load tote 100 may further comprise an extensioner comprising extension straps 57, roof hooks 56, locking block hooks 54, and adjuster 58.

Extension straps 57 may be used to secure load tote 100 (FIG. 1) to vehicle 200 (FIG. 1) such as a station wagon, SUV, minivan, or van that does not have a trunk lid. Extension strap 57 made be made of the same material as hood strap 5 (FIG. 1) or well strap 6 (FIG. 1).

Roof hooks 56 may be secured against a roof carrier (not shown in the figures).

Locking block hooks 54 are adapted to securely receive locking block 1 (FIG. 1) of load tote 100 ((FIG. 1).

Adjuster 58 may be used to securely adjust the length of extension strap 57.

In the operation of an exemplary embodiment, referring again to FIG. 1, hood 55 is opened and locking block 1 positioned to a position where hood 55 can secure locking block 1 such that load tote 100 will be positioned in a desired location on fender 50 near wheel well 52.

Hook 4 is placed to be secured against a lip of wheel well 52. When hook 4 and locking block 1 are positioned, hood 55 is closed to secure locking block 1 and load tote 100 snugged against fender 50 such as by using well strap 6 and well strap lock 11. Hood strap 5 may be tensioned before, after, or concurrently with tensioning well strap 6.

In general, two load totes 100 may be used, displaced from each other along a side of a vehicle, typically along the passenger side. Materials will be placed on flange 2 of each used load tote 100, e.g. on grip 7, and then well strap 6 may be further tensioned to snug and secure the materials against grip 7. By way of example and not limitation, materials to be secured in this manner may include wood such as 2×4s, plastic pipes, metal pipes, tools, small animals, children, boxes, noxious materials, and the like, or combinations thereof.

Flag 12 may then be placed in flag holder 10 to remind the driver of vehicle 200 that materials are strapped to the side of vehicle 200 and to give the driver a gauge as to where flange 2 protrudes from the fender 50. Flag 12 may also serve as a warning device to other drivers.

Referring additionally to FIG. 3, in certain situations a single load tote 100 may be used to carry small packages. This is especially advantageous is the package comprises or contains noxious materials, such as a gasoline can. After securing one or more load totes 100 as disclosed above, carrier 40 may be positioned onto flange 2 (FIG. 1) of one load tote 100 using well strap 6. The package, shown in FIG. 3 as a gasoline can, may be additionally secured such as with carrier strap 42.

It will be understood that various changes in the details, materials, and arrangements of the parts which have been described and illustrated above in order to explain the nature of this invention may be made by those skilled in the art without departing from the principle and scope of the invention as recited in the following claims.

We claim:

1) A load tote, comprising:
a. a locking block adapted to be secured underneath a hood of a vehicle;
b. a hook adapted to be secured in a portion of a wheel well of the vehicle; and
c. a flange, adapted to be operatively secured to the locking block and the hook, the flange further adapted to project outwardly from the vehicle and support a load.

2) The load tote of claim 1 wherein the locking block is at least one of (i) a substantially tubular locking block or (ii) a locking block comprising a first, substantially planar member and a step-shaped endpiece.

3) The load tote of claim 1 wherein the hook is adapted be placed at least partially under a vehicle wheel well to secure the load tote.

4) The load tote of claim 1, further comprising:
a. a strip comprising a first strip end and second strip end, the first strip end comprising an aperture, and an inside and an outside; and
b. a hood strap;
c. wherein
i. the hood strap is adapted to securely connect to the locking block and pass through the aperture in the strip; and
ii. the outside of the strip is adapted to securely fasten to the a first flange end of the flange and a second flange end, the first flange end securely connected to the outside of the strip.

5) The load tote of claim 2, further comprising an adjuster adapted to receive the strip and securely adjust a length of the hood strap.

6) The load tote of claim 4 wherein:
a. the strip and the flange are at least one of (i) a unitary component or (ii) two separate components; and
b. the inside of the strip is adapted to minimize damage to a surface of a fender of a vehicle against which the inside of the strip is placed.

7) The load tote of claim 4 wherein the flange is selectively extendable.

8) The load tote of claim 4, further comprising:
a. a well strap operatively disposed intermediate the hook and the strip; and
b. a well strap lock adapted to substantially secure the well strap into a predetermined position.

9) The load tote of claim 6 wherein:
a. the well strap is securely connected to the second end of the strip; and
b. the well strap passes through first and second apertures of the flange, well strap lock, and the hook aperture.

10) The load tote of claim 6 further comprising a tensioner operatively connected to the well strap.

11) The load tote of claim 8 wherein the tensioner further comprises a ratcheting tensioner.

12) The load tote of claim 1 further comprising a flag holder disposed proximate the flange.

13) The load tote of claim 1 wherein the flange further comprises a grip disposed about a length of an upper surface of the flange.

14) The load tote of claim 10 wherein the grip and the flange are a unitary component.

15) The load tote of claim 1 further comprising a carrier adapted to be securely received by the flange.

16) The load tote of claim 1 further comprising an extensioner, the extensioner further comprising:
a. a roof hook further comprising a first end adapted to be secured against a vehicle roof carrier and a second end;
b. a locking block hook further comprising a first end adapted to securely receive the locking block and a second end; and
c. an extension strap securely attached to the second end of the roof hook and the second end of the locking block hook, the extension strap adapted to pass through an adjuster capable of securely adjusting a length of the extension strap.

17) A method of using an adjustable load tote, the adjustable load tote comprising a locking block adapted to be secured underneath a hood of a vehicle; a strip comprising a first strip end and second strip end, the first strip end comprising an aperture, and an inside and an outside; a hood strap securely connected to the locking block, the hook strap adapted to pass through the aperture in the strip and further adapted to pass through an adjuster useful for securely adjusting a length of the hood strap; a flange comprising a first flange end and a second flange end, the first flange end securely connected to the outside of the strip, the flange further comprising a first aperture disposed proximate the first flange end and a second aperture disposed proximate the second flange end; a hook comprising an aperture; a well strap; and a well strap lock, the method comprising:
a. opening a vehicle hood;
b. positioning the locking block into a space exposed by the opened vehicle hood;
c. securing the locking block in place by closing the vehicle hood;
d. positioning the hook into a desired position proximate a wheel well;
e. securing the load tote into position by tensioning at least one of the hood strap and the well strap;
f. placing materials onto the flange; and
g. securing the materials onto the flange using the well strap.

18) The method of claim 15 wherein the load tote is a plurality of load totes.

19) The method of claim 15 further comprising:
a. securing a first end of a first load tote to a roof carrier of the vehicle; and
b. securing a second end of the first load tote to a locking block of a second load tote.

20) An adjustable load tote, comprising:
a. a locking block adapted to be secured underneath a hood of a vehicle;
b. a hook adapted to be secured in a portion of a wheel well of the vehicle; and
c. a flange, adapted to be operatively secured to the locking block and the hook, the flange further adapted to project outwardly from the vehicle and support a load.
